(19) United States
(12) Patent Application Publication
(10) Pub. No.: US 2005/0044364 A1
(43) Pub. Date: Feb. 24, 2005

(54) Secure content system and method

(76) Inventor: William S. Johnson JR., Jamestown, NC (US)

Correspondence Address: WITHROW & TERRANOVA, P.L.L.C., P.O. BOX 1287, CARY, NC, 27512, US

(21) Appl. No.: 10/945,730

(22) Filed: Sep. 21, 2004

Related U.S. Application Data
(62) Division of application No. 09/798,411, filed on Mar. 2, 2001.

(51) Int. Cl. H04L 9/00; G06F 11/30

(52) U.S. Cl. 713/170; 713/176; 713/187

(57) ABSTRACT

The present invention relates to a system and method for distributing files, such as data files, executable files, and web page content files, between an unsecure server and a client. The client is capable of authenticating the transferred file to determine if the creator of the file has been previously authorized to create files for the client. The file creator may be the original equipment manufacturer (OEM) of the client. The file creator may be a third party that is not the same party as the OEM of the client.

### FIELD OF THE INVENTION

The present invention relates to a system and method for distributing files, such as data files, executable files, and web page content files, between an unsecure server and client. The client is capable of authenticating the transferred file to determine if the file has been created by an authorized producer.

### BACKGROUND OF THE INVENTION

Current methods of security exist between server and client computer systems that exchange information. Such information may be in the form of data files, or the information may be an executable file that is executed on the receiving computer system. Some computer systems provide security for files exchanged by encrypting the data in the file. Certificates are another method of certifying information sent between a server and a client, but such certificates can be stolen or replaced if the server is not in a protected and secure environment. Parties that have access to the server can tamper with the server to obtain a copy of the certificate or alter the certificate. Such certificates, because of their vulnerability, may have to be issued by third party issuing agents thereby adding complexity and cost to providing security.

It is easier to provide security and to prevent interception of files exchanged between a server and a client if the server and client are in secure locations, whereby only authorized personnel have access to the server. In this manner, an unauthorized interceptor of the file is not able to modify the server or client itself to obtain the information needed to decrypt the file or to modify the security systems in place, such as encryption keys and algorithms.

However, many computer systems with server and client architectures are in unsecure locations. Examples of unsecure systems are common in retail environments, such as a convenience store and fuel dispensing for automobiles. Often times, these retail environments include point-of-sale systems that are used as servers to transfer and control information distributed and displayed to customers. These point-of-sale systems are located inside a convenience store and are accessible to operators inside the convenience store thereby making these systems unsecure.

The files exchanged between servers and clients may contain a mark-up language or some other form of common Internet type protocol, such as HyperText Markup Language (HTML), eXtended Markup Language (XML), or Java®. The knowledge and ability to use such languages is wide spread thereby increasing the possibility of parties to tamper with file transfers and operation between unsecure servers and clients. Station operators or other persons may tamper with the point-of-sale system to provide content in the form of an Internet type language that is sent to the fuel dispenser and executed without authorization.

Many client systems in the retail environment, such as fuel dispensers, accept personal customer information, such as credit and debit card accounts. Such information is obtained through executable content and files supplied by the server. If a party is able to modify the point-of-sale server to send out modified content through an unsecure server, such person may be able to fraudulently obtain sensitive customer information that is not intended for distribution or use without authorization.

Therefore, a need exists to provide a system and method to provide a means to transfer authorized files between unsecure servers and clients so that third parties cannot modify the server or the files to obtain sensitive information and/or cause the client to perform actions not authorized or intended.

### SUMMARY OF THE INVENTION

The present invention relates to a system and method for determining if downloaded files transferred to a client from a server are authorized. Such downloaded files may be Internet applications or other files, such as hypertext markup language (HTML) files, Java applets, Java scripts, or the like. These downloaded files may control the operation of the client, including controlling the client display, PIN pad, printer, keypads, touch-screen, and magnetic card reader.

A digital signature is added to web page components to prevent unauthorized web pages from being used to fraudulently obtain payment system identification from customers. The digital signature is calculated and appended to contents of the downloaded files at an original equipment manufacturer (OEM) where a private key, that must be used to create a digital signature, is kept secret. An OEM or third party may only sign a portion of a file to be transferred to the client using a digital signature. Such file portions may control the actions of peripherals controlled by the client. These file portions must have a digital signature attached in order to be authenticated by the client.

In one embodiment, the file creator and the OEM are the same party. The OEM signs a file to be transferred using a digital signature, using the OEM's private key. The OEM public key is stored in the client. The file is transferred to an unsecure server and then to a client for handling and/or execution. The digital signature is authenticated using the public key stored in the client. If the digital signature is authenticated, the file is allowed to remain resident in and/or be executed on the client. If the digital signature is not authenticated or if a digital signature is not attached to the file, the client may decide not to keep the file resident in memory and/or execute the file or a portion of the file.

In another embodiment, the file creator is a third party and is not the same party as the OEM of the client. The third party generates its own public and private key pair. The third party sends its public key to the OEM of the client before transferring any files and keeps its private key secret. The OEM receives the third party public key and calculates a digital signature for the third party public key using the using the OEM's private key. The OEM then sends the signed third party public key back to the third party. The third party creates files, such as web pages and other content for the client, and uses the third party's private key to create a digital signature of such files.

The third party sends the signed public key to the client. The client uses the stored OEM public key to authenticate the third party's public key. If the third party public key is authenticated, the client stores the third party's signed public key. The client may the use the third party's public key to authenticate downloaded files from the third party.

The client may handle the third party keys in various ways. The client may allow only one third party public key to be in use at any given time. The client may allow multiple third party public keys to be in use simultaneously. The client may also allow only third party public keys that are signed by the OEM's private key. The client may allow authenticated third parties to sign other third party public keys with the only restriction being that the client must be loaded with third party keys in the correct order of signage, starting with the third party key that was signed by the OEM.

### BRIEF DESCRIPTION OF THE DRAWINGS

FIG. 1 is a schematic illustration of a prior art embodiment of a server-client architecture;

FIG. 2 is a perspective illustration of an exemplary retail station;

FIG. 3 is a schematic illustration of a point-of-sale-retail device in the server-client architecture;

FIG. 4 is a flowchart illustrating the initialization process of a client system;

FIG. 5 is an illustration of a web page executing on the client;

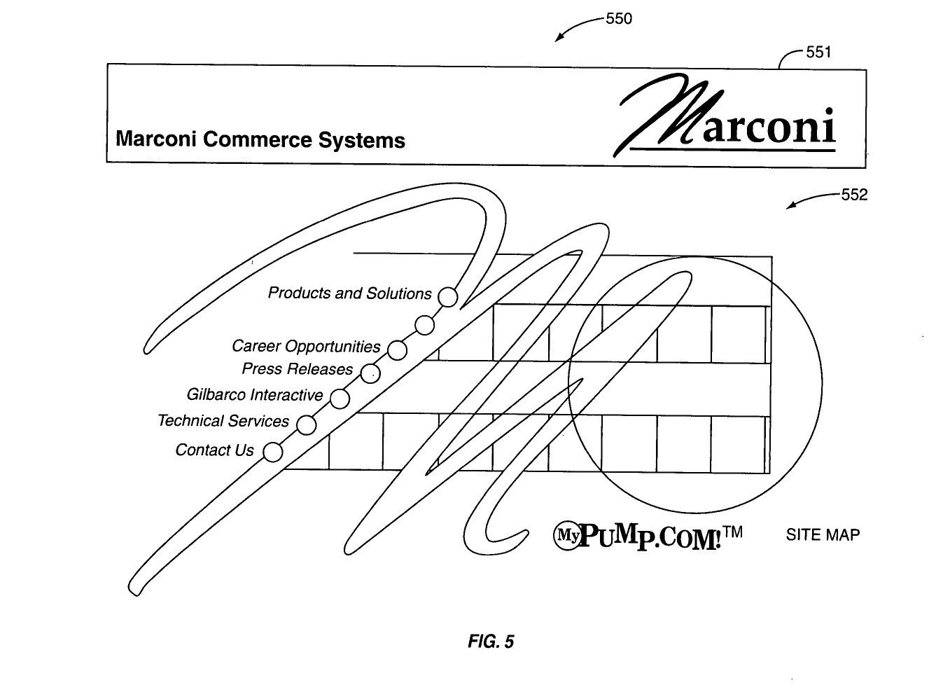

FIG. 6 is a flowchart illustrating the operation of the common server-client system;

FIG. 7 is a flowchart illustrating the special handling of a file in the common server-client system;

FIG. 8 is a flowchart of a third party generating its private and public keys and having the public key signed by the OEM;

FIG. 9 is flowchart illustrating the downloading of a signed third party public key and file to the client; and

FIG. 10 is a flowchart illustrating special handling of a file in the third party file.

### DETAILED DESCRIPTION OF THE INVENTION

The present invention relates to a system and method for exchanging authorized information to a client, in the form of files, when the server is in an unsecure location. An unsecure server is a computer system that is in an unsecure area and out of the control of its original equipment manufacturer (OEM). The OEM is the party that constructs or distributes the hardware and software that comprises the client.

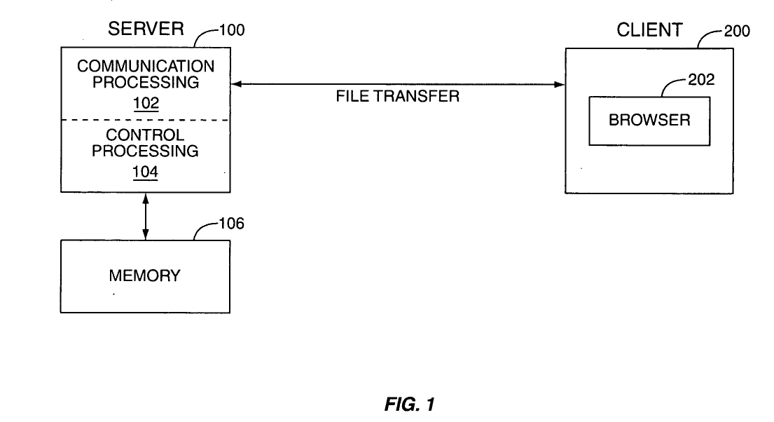

Turning to FIG. 1, a typical computer system for information exchange is shown that is known in the prior art. A server 100 includes a communication processing 102 and control processing 104 for carrying out its intended functions and for communicating with other systems, including a client 200. Client 200 may be located remotely from server 100 or located in close proximity to server 100. In one embodiment, client 200 is a computer used to allow a customer (or attendant in some cases) to complete a sales transaction and which includes means to display information to the customer, means to accept methods of payment including a credit or debit card, means to produce a receipt, and means to collect customer identification (PIN numbers) for debit cards or other payment media when required.

Client may also contain a browser 202 to execute content from files downloaded from server 100 to client 200. Data associated with the operation and configuration of server 100 is held in an associated memory 106. Memory 106 may also be configured to store content information and files in the form of Internet type languages and protocols such as HTML, XML, Java, etc. Server 100 communicates with client 200 using a TCP/IP-based protocol to transfer a file. The file transfer may also be other types of file transfer protocols or systems, and is not limited to TCP/IP-based transfers.

During communications, server 100 retrieves files (not shown) from memory 106 associated with the control-processing portion of server 100. Server 100 then transfers the file to client 200. The file may be composed of HTML or other markup language or a control program such as Java applets or Java scripts, or some other language. Browser 202 is resident in client 200 and interprets mark-up language files transferred to client 200. One example of this system is disclosed in U.S. Pat. No. 6,052,629, entitled “Internet capable browser dispenser architecture,” and U.S. Pat. No. 5,980,090, entitled “Internet asset management system for a fuel dispensing environment,” both of which are incorporated herein by reference in their entirety.

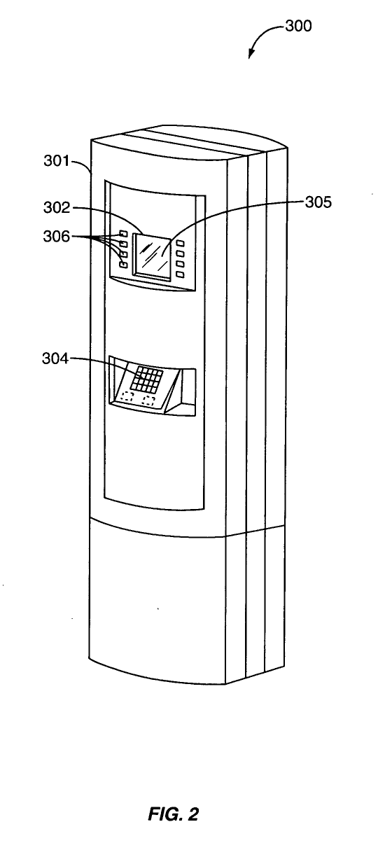

FIG. 2 illustrates one embodiment of client 200 as a retail station 300. A retail station 300 is a system equipped and operative for interaction with customers to facilitate the purchase of goods and/or services. Alternatively, but not mutually exclusive, the retail station 300 may interact with a customer in the form of displaying information through a display 302 and/or receiving input. For example, goods purchased at the retail station 300 may comprise information, data, or entertainment in electronic form. Examples of information include news reports, weather forecasts, and music, video, or other content in electronic format, that the customer many order and purchase at the retail station 300, and that may additionally be downloaded directly into the customer's automotive computer, handheld computing device, musical playback device, or the like. Services may include a car wash purchase, placing a telephone call, ordering a movie rental, etc. As illustrative examples, the following pending patent applications are incorporated herein in their entirety: Ser. No. 09/483,074, “Multistage Data Purchase,” describing a retail transaction station for the delivery of information purchased over a computer network; Ser. No. 09/482,281, “Multistage Forecourt Data Order and/or Purchase,” describing the order and purchase of a variety of goods and services through a retail transaction station in a fueling environment; and Ser. No. 09/483,079, “Retailing Audio Files in a Fuel Dispensing Environment,” describing the order and purchase of music through a retail transaction station in a fueling environment. The retail station 300 may also provide advertising to customers. Another example of a retail station 300 may include a vending machine. One such device is described in PCT Patent Application WO 96/06415, “Method and Apparatus for Vending Goods in Conjunction with a Credit Card Accepting Fuel Dispensing Pump,” the disclosure of which is incorporated herein in its entirety. In general, any type of goods and/or services may be ordered and purchased through a retail station 300; the above examples are illustrative only, and not limiting.

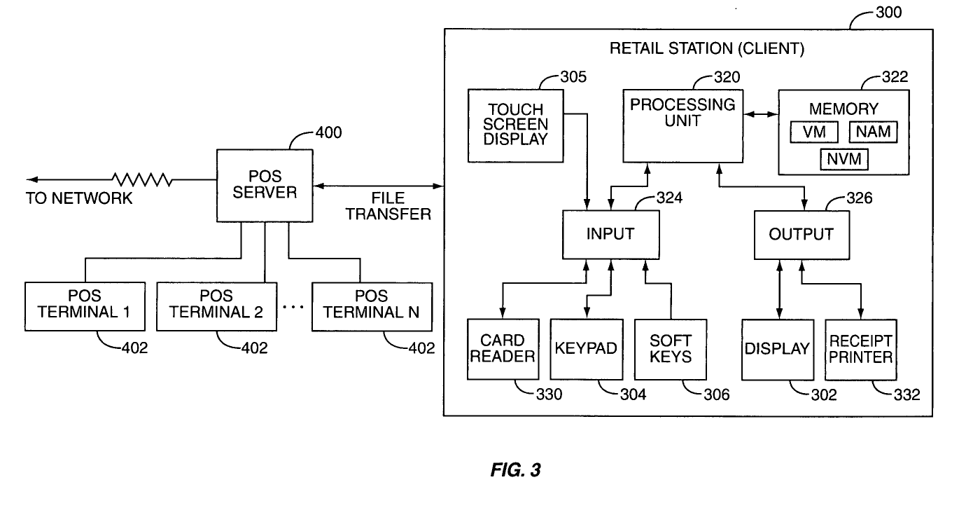

Retail station 300 may contain at least one input device 324 (illustrated in FIG. 3) to allow customer interaction with retail station 300. The input device 324 may comprise a mechanism requiring tactile contact by the consumer, for example a keyboard or keypad 304, touch screen display 305, or programmable function keys 306, sometimes called “soft keys.” If display 302 is a touch screen display, touch screen keys 305 may be included as an input device in addition to or in lieu of other input devices, such as soft keys 306 or keypad 304. Alternatively, the input device 324 may be of a form that requires no physical contact, such as a transponder or other wireless communication device, a smart card, speech recognition, or a direct link to a secondary device such as a PDA or laptop computer. In the embodiment depicted in FIG. 2, the retail station 300 contains a keypad 304 disposed in housing 301, and soft function keys 306 disposed along display 302 as the input devices 324.

Retail station 300 may also contain a payment device for allowing the customer to pay for purchases. This may be done directly, for example, with a cash acceptor operative to accept and verify currency and coins. One example of a cash acceptor is described in U.S. Pat. No. 5,842,188, “Unattended Automated System for Selling and Dispensing with Change Dispensing Capability,” incorporated herein by reference in its entirety. Alternatively, the payment device may be effective to read transaction account information from a payment card reader, such as a magnetic stripe card reader. Alternatively, or additionally, a payment device may comprise an interrogator effective to read payment information wirelessly from a customer transponder. An illustrative example of a transponder payment device is disclosed in U.S. Pat. No. 6,073,840, “Fuel Dispensing and Retail System Providing for Transponder Prepayment,” the disclosure of which is incorporated herein in its entirety. The payment device may alternatively comprise an optical reader effective to detect and interpretive visual indicia, such as a bar code. An illustrative example of a bar code reader payment device is disclosed in U.S. Pat. No. 6,062,473, “Energy Dispensing System Having a Bar Code Scanning Unit,” the disclosure of which is incorporated herein in its entirety.

Additionally or alternatively, the payment device may be effective to recognize the consumer, either to thereby associate previously stored transaction account information with the consumer, or as a security measure to validate transaction account information otherwise received. This may comprise, for example, a camera and associated facial recognition system. As an example of a retail transaction station having a camera incorporated therein, the disclosure of U.S. Pat. No. 6,032,126, “Audio and Audio/Video Operator Intercom for a Fuel Dispenser” is incorporated herein in its entirety. Alternatively, a payment device with customer recognition may include a biometric sensor, for example, a camera effective to detect and interpretive eye iris patterns, a fingerprint detector, or the like.

Retail station 300 may additionally include an output device 326 (illustrated in FIG. 3) to facilitate communication with the customer. The output device 326 may present the customer with instructions, advertising, and/or various menus or other selections of goods and/or services available for purchase. In the embodiment illustrated in FIG. 2, the output device 326 is a display 302 that is a flat screen liquid crystal display (LCD). Additionally, an output device 326 may comprise a text or graphic output display, that may be of any technology or type known in the art, illustratively including any of a variety of liquid crystal displays (LCD), both Passive Matrix (PMLCD) and Active Matrix (AMLCD)—including Thin-Film Transistor (TFT-LCD), Diode Matrix, Metal-Insulator Metal (MIM), Active-Addressed LCD, Plasma-Addressed Liquid Crystal (PALC), or Ferroelectric Liquid Crystal Display (FLCD). Alternatively, the display 302 may comprise Plasma Display Panel (PDP), Electroluminescent Display (EL), Field Emission Display (FED), Vacuum Fluorescent Displays (VFD), Digital Micromirror Devices (DMD), Light Emitting Diodes (LED), Electrochromic Display, Light Emitting Polymers, video display (cathode ray tube or projection), holographic projection, etc. The display technologies discussed above are illustrative in nature, and not intended to be limiting.

The output device 326 may be audible. Additionally, the output device 326 may provide for the actual delivery of goods in electronic form. This may be accomplished through communication to a secondary device, such as a computer in the consumer's automobile, a PDA or laptop computer, a mobile telephone terminal, a musical playback device, or the like. Connection to the secondary device may be through a wired connection, as through a plug provided on the retail station 300, or over a wireless radio or optical connection.

In the embodiment depicted in FIG. 2, the retail station 300 contains an output device 326 in the form of a display 302 disposed in housing 301. Soft function keys 306, disposed along the sides of display 302, may be programmed to cooperate with a menu presented on display 302 to facilitate interaction with the customer.

FIG. 3 illustrates one embodiment of server 100 and client 200 in a retail environment, such a retail store or fuel station convenience store. The server 100 is in a point-of-sale (POS) device called a POS server 400, such as that disclosed in U.S. Pat. No. 6,067,527 entitled “Point of sale system, method of operation thereof and programming for control thereof,” incorporated herein by reference in its entirety. A POS server 400 is a main controller (a computer) of a POS system that controls and coordinates all the activities of the POS system. Note that there may be more than one server in a given POS system. The server and the terminal may also be contained in one computer. POS server 400 distributes web pages (files) as required to the client machine.

Additional POS terminals 402 may be located in the retail environment for use by operators in conducting retail transactions, but these POS terminals 402 are also served by a POS server 400 in the retail store. POS server 400 may be connected to a network for remote communications of information such as credit and debit card purchases and content information to be transferred to the retail station 300, and for other monitoring such as that disclosed in previously incorporated U.S. Pat. No. 5,980,090. The transferor of the file may transfer the file to POS server 400 to then be transferred to retail station 300.

As previously discussed, information transfer occurs between POS server 400 and retail station 300 in a server-client architecture. The retail station 300 includes a processing unit 320, such as a microprocessor or other control unit that controls the operation of the retail station 300 and receives information from POS server 400. The processing unit 320 has associated memory 322 in the form of both volatile (VM) and non-volatile memory (NVM). In one embodiment, the non-volatile memory is FLASH memory that is well known in the art. Input and output devices 324, 326 are communicatively connected to the processing unit 320 so that the processing unit 320 can receive input from input devices 324 present in the retail station 300 and control output devices 326 in the retail station 300 as needed. In the embodiment illustrated in FIG. 3, the input devices 324 are comprised of a magnetic card reader 330, keypad 304, touchscreen 305, and soft keys 306. The output devices 326 are comprised of display 302 and a receipt printer 332. The receipt printer 332 gives a customer an accounting for any goods and/or services purchased. Additionally, the receipt printer 332 may also be used to give coupons, advertising, and other information.

### Digital Signature

A digital signature is one method of ensuring that a file, such as files transferred between server 400 and a client 300 (see FIG. 3), are authorized. More generally, a digital signature is used to authenticate the contents of any particular group of digital data. That digital data may be, an operating program, a digital image, an HTML web page, a text message, or whatever the user wishes to authenticate. In it's basic definition, a digital signature says “I wrote this page and I signed it” where the “I” represents the person or entity that is able to create the digital signature. A digital signature is most usually appended to the end of the data being signed but it could be embedded within the data in some circumstances. In a digital signature scheme that uses public and private keys, the “I” is the person or entity that owns the private key. With the private key, the key owner is able to create the digital signatures. The owner of the private key keeps it secret.

The public key can be either published or stored in a non-secure manner since it does not have to be kept secret. However, in this invention, the public key is stored in such a manner, as previously discussed, that it cannot be erased, modified, or replaced. The public key can only be used to verify that the digital signature is authentic. It cannot be used to generate a digital signature.

An example of a digital signature system that uses private and public keys is the one defined in FIPS (Federal Information Processing Standard) publication 180 and 186. This version of a digital signature is referred to as the Digital Signature Standard (DSS). The DSS is used in one embodiment of this invention. But other digital signature schemes can be used for the same purpose within this disclosure, and the present invention is not limited to any particular type of digital signature scheme. This DSS applies in the context of the present invention, where the sending party is server 400 and the receiving party is client 300 (see FIG. 3).

### File Transferor Same as OEM

In one embodiment of the present invention, the file creator is the same party as the manufacturer of the retail station 300 and the server 400. An authentication system is implemented that ensures that files transferred between POS server 400 and the retail station 300 are identified as authenticated or authorized.

In client 300, the software is divided into two pieces, first the boot portion, which is loaded into the machine at the factory and cannot be changed in the field. This is done by using flash memory, of which the portion containing the boot code can be ‘secured’ or protected from change in the field. In practice, this is done by applying voltages to the flash memory component which are not normally present on the computer board. The boot portion of the code also contains the public key of a digital signature system. The flash memory is not ‘read’ protected so knowledge of the public key may be gained. But this is not critical to the operation and security of the digital signature system. The boot portion of the code is responsible for loading the operating code for the client machine and verifying the digital signature of the operating code.

The second portion of the flash memory contains the operating code for the client machine. It is downloaded to client 300, either in the field or in the factory. The operating code must have a digital signature appended to it. If the digital signature cannot be verified by the boot code using the stored public key, the operating code will not be executed by client 300. The digital signature of the operating code is stored and checked at the time of loading and every time the system power is applied.

The operating code of the client 300 includes a browser or browser like software device which is capable of displaying web content and accepting other Internet content such as Java applets, Java script, or other controlling code.

The downloaded Internet applications or files (HTML, Java applets, Java scripts, etc.) are capable of controlling operation of the display, the encrypting PIN pad, the printer, the softkeys or touchscreen, and the card reader. This information and content is stored on the server part of the POS system and is downloaded to the client when requested or required. The client machine may also store (or cache) Internet applications or files that have been downloaded to it for later use. The server is located at the location of the business and is not considered a secure location. Each item of content to be displayed or downloaded to the client machine as part of the Internet content has a digital signature applied to it.

The digital signature is calculated and appended to the various Internet contents at the original equipment manufacturer where the private key is kept secret. The private key may be used to create a digital signature. The original equipment manufacturer also generates the web pages and other files to which the digital signatures are attached.

If an HTML page is to be downloaded to the client, then that HTML page must have a digital signature stored with and attached to it. When the page is received at the client machine, the client machine will authenticate the digital signature attached to the page and allow it to be displayed. The digital signature is authenticated using the public key stored in the boot section of the flash memory. If the digital signature is authenticated, then the page will be displayed and other actions within the client machine will be allowed to continue. If the signature was not authenticated, or if a digital signature was not attached, then the client machine may decide to not display the page, or it may decide to display the page but not allow any subsequent input to the client machine from the client peripherals to be passed back to the server.

Other possible contents of the data sent to the client machine are equally important and require a digital signature. Java applets downloaded to the client machine are used to control the actions of the peripherals attached to the client CPU. They must also have a digital signature attached in order for them to be executed by the client machine software. The Java applet which controls the encrypting PIN pad is important because if the PIN pad can be put into a non-encrypting mode, bogus commands could allow the use of the PIN pad during PIN entry which may not in fact encrypt the PIN number. There are many other scenarios where lack of a digital signature may allow illegitimate use of the client machine.

Since only the OEM has knowledge of the private key, only the OEM can generate the required digital signatures for all of the Internet content to be sent to the client 300 to allow complete operation of the client 300.

Many variations are possible with the use of the digital signature scheme outlined here. For instance, the OEM may elect to exclude certain portions of an HTML web page from the digital signature calculation. As an example, consider a web page where a banner advertising JPG image is defined at the top of the page and it's size is restricted by the HTML definition of the image. The HTML content is then signed but that excludes the actual content of the image. Then the contents of the image may be changed ‘on the fly’ in the field to react to other requirements such as presenting an advertisement targeted to a particular customer. By including only the name and size of the image in the digital signature, the OEM has allowed the content of the image to be changed by others, but the size restriction keeps an illegitimate image from being used to compromise the customer's payment authentication data.

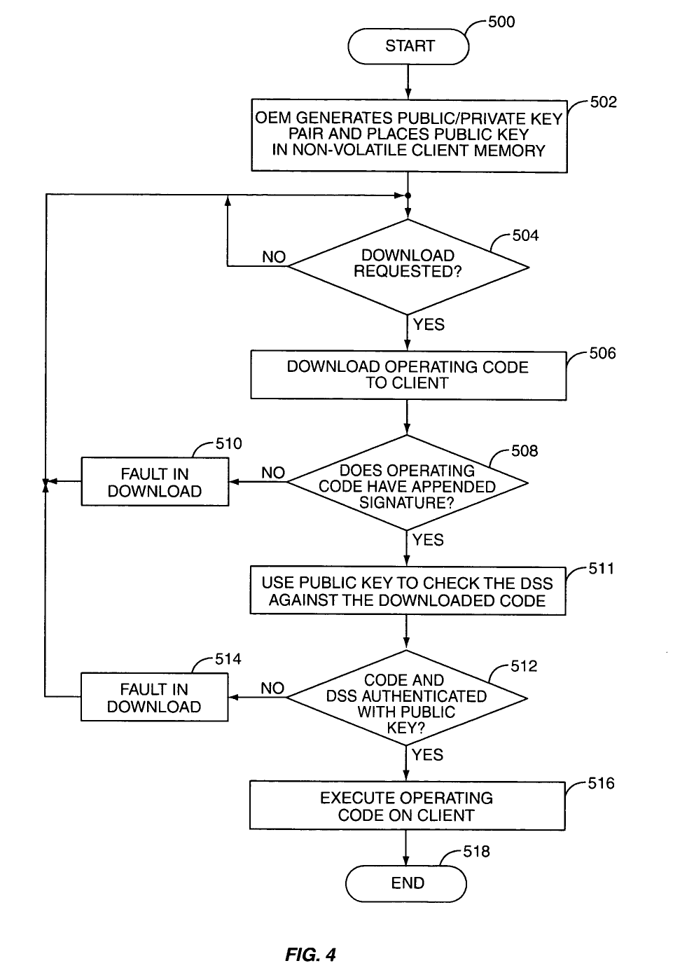

This process is illustrated in a flowchart in FIG. 4, and is described as follows. The process starts (block 500, FIG. 4), where the manufacturer of POS server 400 and retail station 300 generates a key pair, consisting of a public and private key (block 502). The public key is placed in the non-alterable memory (NAM) 322 of the retail station 300 during manufacturing. The private key is kept secret by the OEM party, and is not placed in either POS server 400 or the retail station 300. The OEM also places boot software in non-alterable memory of the retail station 300 during manufacturing. The boot software is software that is executed by the processing unit 320 when powered is applied to the processing unit 320. The boot software starts in memory 322 at the location of the reset vector address of the processing unit 320. One of the main purposes of the boot software is to download application software from POS server 400 or by other downloading device, such as a laptop computer connected directly to the retail station 300, at initialization of the retail station 300. The application software runs the normal processing and operation of the retail station 300.

Once the boot software begins executing, it determines if an application software download has been requested to be performed by POS server 400 or other downloading device, such as a laptop computer or PDA connected to a port on the retail station 300 (decision 504). If an application software download has not been requested, the process continues to determine if a download has been requested until such occurs. If a download is requested, POS server 400 or other downloading device downloads the application software to the retail station 300 (block 506). The boot software checks to see if the application software has a digital signature appended to it (decision 508). The OEM of the authorized application software has included a digital signature on the application software ahead of time before the software is downloaded to the retail station 300 using its private key. The OEM is the only party that possesses its private key.

If the application software does not have a digital signature appended to it, a fault has occurred in the download (block 510), and the process returns to checking to see if a new download request has been received (decision 504). The fault may generate an alarm condition at the retail station 300, POS server 400, or at a remote location communicatively connected to either the retail station 300 or POS server 400. In addition, the retail station 300 may be inoperable until authorized application software is downloaded.

If the application software has a digital signature appended to it, the boot software checks the digital signature against the downloaded code using the previously stored public key to determine if the digital signature is valid (block 511). The boot software determines the next step based on whether the signature is valid (decision 512). If the boot software determines that the operating software does not contain a valid signature, a fault condition is generated (block 514), as discussed in the previous paragraph, and the process returns to determine if a new application software download has been requested (decision 504). If the signature appended to the application software is authentic, the boot software turns over control of retail station 300 to the application software. Processing unit 320 executes the operating software, which operates retail station 300 in its intended manner (block 516) and the authentication process ends (block 518).

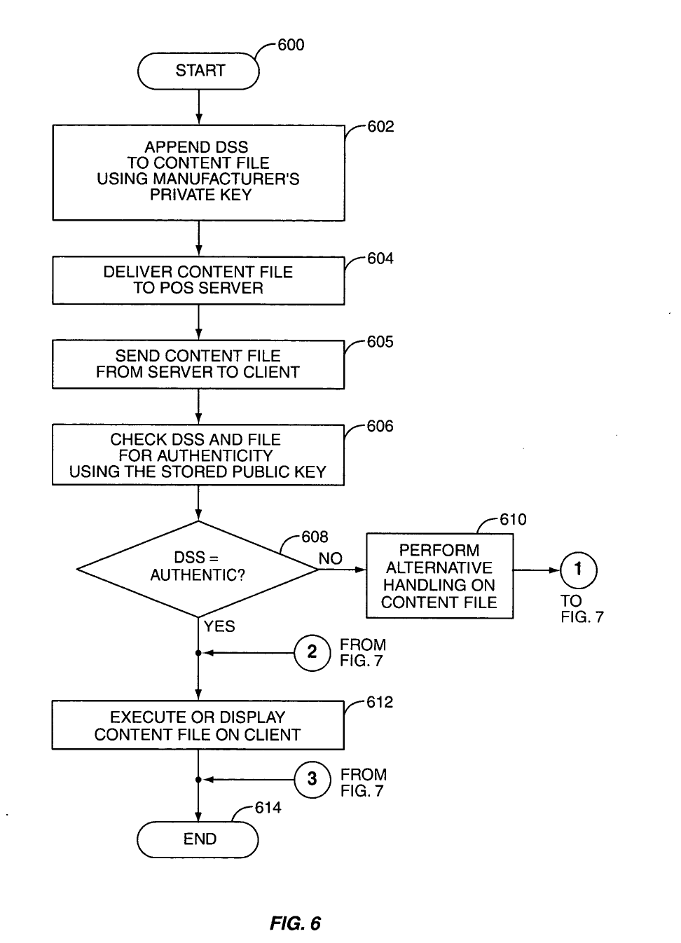

FIG. 6 illustrates an alternative embodiment of the present invention whereby the OEM only signs on a particular portion of a file, such as a web page content file. In this embodiment, the file creator is still the same party as the OEM of retail station 300 and server 400, previously discussed and illustrated in FIG. 3. This content file transferred between POS server 400 and retail station 300 may be transferred after the operating software has been downloaded and is operational in retail station 300. Such additional content files may be information only or executable files to be executed only in particular circumstances.

For instance, the OEM may elect to exclude certain portions of a HTML web page from the signature calculation. Consider a web page 550, where a banner 551 is defined at the top of the web page where it is desired to restrict the banner 551 width and height. Banner content 551 may contain advertising or other information to be displayed on retail station 300 to the customer. The web page 550 also contains content information 552. It may be desirable to not restrict changes by third parties to banner content 551 but restrict such third parties from changing the content information 552. Banner content 551 may change to react to other requirements of retail station 300, such as presenting an advertisement or instructions to a particular customer based on the previous inputs or responses to retail station 300. If the OEM has only signed the contents of the web page 550, or other particular restrictions desired to not be modified by third parties, this allows third parties to change the banner content 551 as needed or desired without being able to modify the restricted areas of the web page 550, such as the content 552.

This process is illustrated in FIG. 6. The process starts (block 600), and the OEM appends its signature, also known as DSS, to the desired portion of the content file, using the OEM's private key (block 602). The content file is delivered to POS server 400 either by electronic communication or by a downloading device directly connected to POS server 400 (block 604). The content file is sent from POS server 400 to retail station 300 when desired (block 605). The content file may be a particular web page application that is only to be displayed on retail station 300 for a particular option selected by the customer at retail station 300. The application software or boot software, depending on the configuration of the system, uses the public key to authenticate the signature with the file contents (block 606), and retail station 300 decides if the signature is authentic (decision 608). If the signature is not authentic, retail station 300 performs alternative handling on the content file (block 610). If the content file is authenticated, the content file is executed by processing unit 320 on retail station 300 (block 612), and the process ends (block 614).

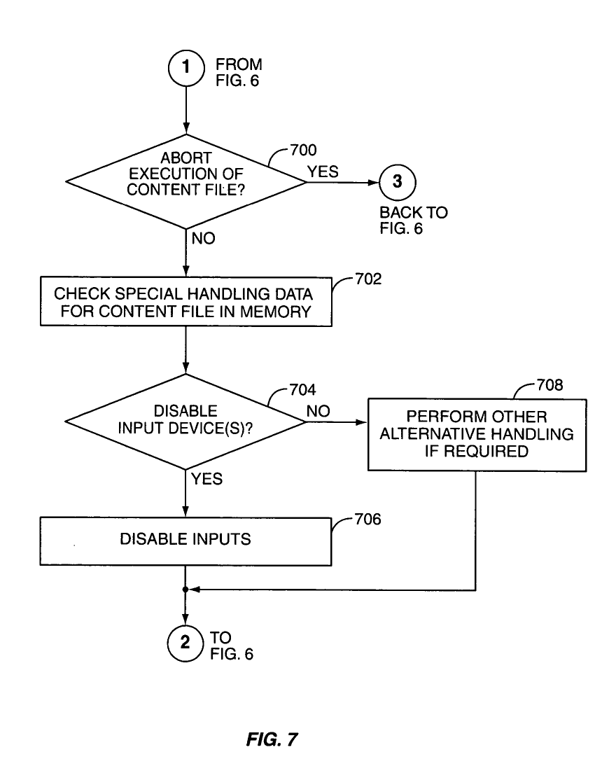

If the content file was not authenticated (decision 608), alternative handling is performed on the content file (block 610) as illustrated in the flowchart in FIG. 6. The alternative handling process is illustrated in FIG. 7. Processing unit 320 first determines if execution of the content file should be aborted by determining the configuration information concerning alternative handling of content files stored in memory 322 (decision 700). If the content file execution is to be aborted, the process ends (block 614 from FIG. 6). If the content file is to be executed, but in a special manner, the special handling data for non-authenticated content files is checked in memory 322 (block 702). If the special handling data requires that input devices 324 at retail station 300 be disabled (decision 704), processing unit 320 causes the input devices 324 to be disabled (block 706), and the content file is executed (block 612 from FIG. 6). In this manner, the content file is still executed on retail station 300, but the customer cannot interact with the input devices 324 disabled. If the input devices 324 are not to be disabled, any other alternative handling is performed as dictated by the special handling data in memory 322 (block 708), and the content file is executed (block 612 from FIG. 6).

### Third Party File Transferor to Client

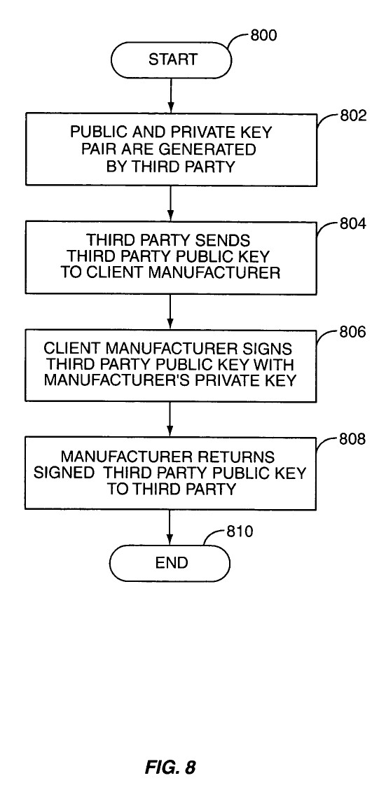

Another embodiment of the present invention relates to a third party, unrelated to the OEM of POS server 400 and client 300, that desires to transfer a file to retail station 300. FIGS. 8-10 illustrate flowcharts describing this embodiment.

Another consideration is how to maintain the security of the system when the client machine is sold to be operated with a third party server and terminal POS system. In this case, the third party must be able to create web pages and other content to be able to serve the requirements of the purchaser. This is solved in the following manner. The third party POS system manufacturer creates a suitable private and public key pair for use with the particular digital signature system in use in the client machine. The third party POS manufacturer sends his public key to the Original Equipment Manufacturer and keeps his private key secret. The OEM receives the third party public key and calculates a digital signature for that key using the OEM private Key. The OEM then returns the signed third party public key to the third party. The third party creates web pages and other content for the OEM client machine using the third party's private key to create digital signatures for his web pages and content. In the field, the third party first sends the signed public key (signed with the OEM's private key) to the Client Machine. The Client Machine uses its stored OEM public key to authenticate the third party's public key. If it is authenticated, then the client machine stores the third party's signed public key in its memory. The client can then use that third party public key to authenticate downloaded web pages and other Internet content from the third party POS system.

The operating software within the client machine may handle the third party keys in various ways. It may allow only one third party public key to be in use at any given time. It may allow multiple third party public keys to be in use simultaneously. It may allow only third party public keys that are signed by the OEM's private key. It may allow authenticated third parties to sign other third party public keys with the only restriction being that the client machine must be loaded with third party keys in the correct order of signage, starting with the third party key that was signed by the OEM.

FIG. 8 illustrates authorization of the third party with retail station 300. The process authorizes a particular third party with retail station 300 to authorize reception and/or execution of files, such as web page content files, that are transferred from a third party server to retail station 300. The process starts (block 800), and the public and private keys are generated by the third party (block 802). The third party sends its public key to the OEM of retail station 300 (block 804). The OEM signs the third party public key with the OEM's previously generated and secret private key (block 806), and then returns the signed third party public key back to the third party with the signature attached (block 808). The process then ends (block 810). Note that the OEM of retail station 300 is signing the third party public key in this step and not the third party provider of the content file.

The first time that a third party desires to transfer an authorized file to retail station 300, the third party must send its signed third party public key, signed by the OEM of retail station 300, to retail station 300 to be stored as an authorized third party for transferring files. During this part of the process, the third party transfers the content files and the signed third party public key from POS server 400 to retail station 300. However, subsequent transfers of files from the third party to retail station 300, through POS server 400, will not require transfer of the signed third party public key signed by the OEM of retail station 300 unless retail station 300 has been cleared of its third party public keys by other events such as downloading new operating software to retail station 300.

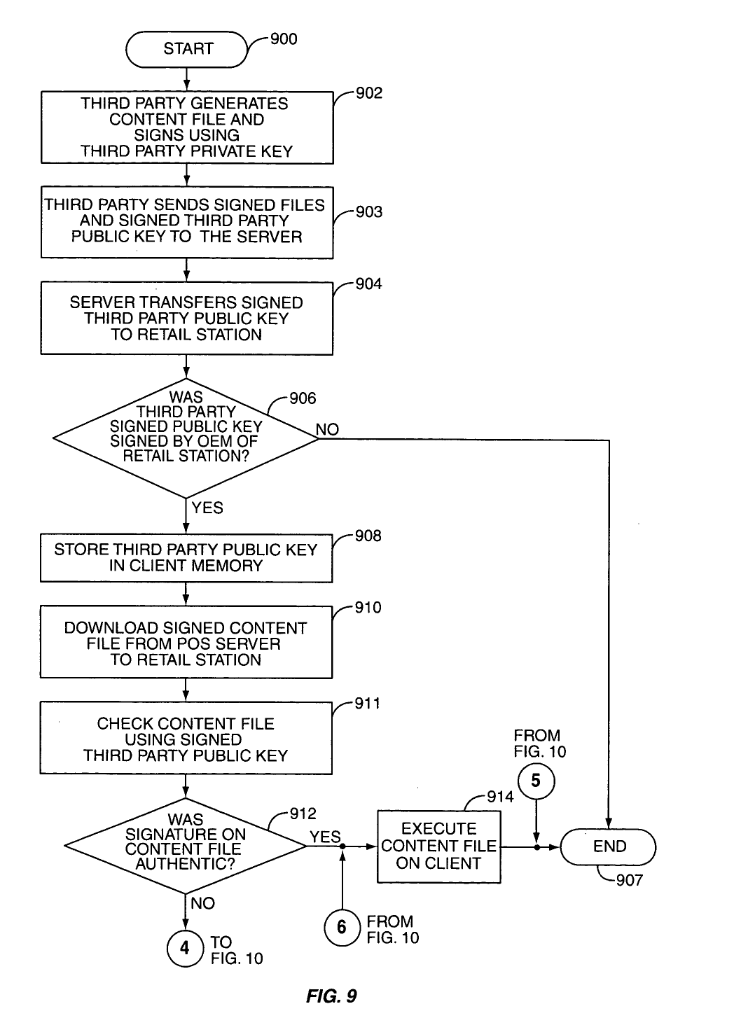

Before the content file is transferred to POS server 400 and/or transferred to retail station 300, the third party generates a content file or files to be later transferred to POS server 400 and signs the content file or files using the third party private key, as illustrated in FIG. 9 (block 902). The third party keeps its private key secret at its location, and does not transfer the private key to POS server 400 or retail station 300. The signed content file or files and the previously signed third party public key are next transferred to POS server 400 (block 903). When retail station 300 requires a content file, POS server 400 first transfers the signed third party public key to retail station 300 for verification (block 904). Retail station 300 processing unit 322 determines if the signed third party public key was signed by the OEM of retail station 300 or other authorized agent (decision 906). If the signed third party public key was not signed by the OEM of retail station 300, this third party is not authorized to transfer files to retail station 300 for execution or other handling, and the process ends (block 907).

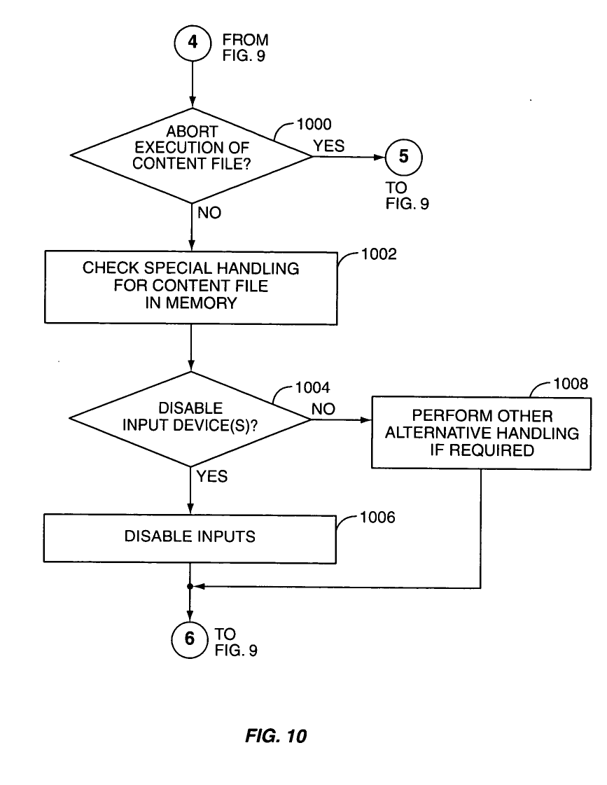

If the signed third party public key was indeed signed by the OEM of retail station 300 or other authorized agent, retail station 300 stores the third party public key in memory 322 (block 908). POS server 400 transfers the signed content file or files to retail station 300 (block 910). Processing unit 320 determines if the signature of the content file was signed using an authorized third party public key stored in memory 322 (block 911). In decision 912, the processing unit 320 branches depending on whether the signature was authentic. If the content file was signed using an authorized third party public key stored in memory 322, the content file is executed on retail station 300 (block 914), and the process ends (block 907). If not, processing unit 320 determines if further processing is required on the content file, as discussed below and illustrated in FIG. 10.

As illustrated in FIG. 10, if the content file was not signed using an authorized third party public key stored in memory 322, it is then determined if the content file should be aborted, meaning not executed or discarded (decision 1000). If the content file should be aborted, the process ends (block 907, FIG. 9). If the content file is not to be aborted, processing unit 320 checks memory 322 to see what special handling of the content file is required (block 1002). If the special handling data requires that input devices 322 at retail station 300 be disabled (decision 1004), processing unit 320 disables input devices 324 (block 1006), and the content file is executed (block 914 from FIG. 9). In this manner, the content file is still executed on retail station 300, but the customer cannot interact with the input devices 324 disabled. If input devices 324 are not to be disabled, any other alternative handling is performed as dictated by the special handling data in memory 322 (block 1008), and the content file is executed (block 914 from FIG. 9).

In the foregoing description, it should be understood that server 100 is not limited to a POS server 400 and that client 200 is not limited to a retail station 300. It should also be understood that files transferred between server 100 and client 200 can be any type of file, executable or not, including web page files such as HTML, XML, Java, Java scripts, etc. and image files such as MPEG, JPEG, TIF, GIF, MOV, AVI, MPG, etc. It should also be understood that any encryption algorithm can be employed that is compatible with the public key/private key concept, and that the signature used in the present invention can employ the DSS, or any other digital signature. The file transfers do not necessarily have to be sent through server. The present invention is applicable to file transfers from the file creator directly to client 200.

It should also be understood that all such modifications and improvements have been deleted herein for the sake of conciseness and readability, but are properly within the scope of the following claims. The present invention is intended to cover what is claimed and any equivalents. The specific embodiments used herein are to aid in the understanding of the present invention, and should not be used to limit the scope of the invention in a manner narrower than the claims and their equivalents.

1-32. (Cancelled)

33. A method of allowing a third party to author web content for a OEM client, comprising the steps of:
said third party generating a private key and a public key, wherein said private key is kept secret;
sending said third party public key to the OEM;
said OEM signing said third party public key using the OEM private key;
said OEM sending said signed third party public key back to said third party.
said third party generating web content pages;
said third party signing said third party web content pages using said third party private key;
said third party sending said third party signed public key to said client;
said client checking said signature of said signed third party public key to determine if said signed third party public key is authentic;
said client accepting and storing said signed third party public key if the digital signature is authentic;
said third party sending said third party signed web content to said client; and
said client authenticating said signed third party signed web content using said signed third party public key;
said client executing or displaying said third party web content if said third party digital signature is authentic;
said client not executing or displaying said third party signed web content if said third party digital signature is not authenticated with the said signed third party public key.

34. The method of claim 33, wherein said third party digital signature can be applied to the entire said third party web page as a whole including all display and control components.

35. The method of claim 33, wherein said third party digital signature can be applied to each of said individual components of said third party web page including all display and control components.

36. The method of claim 33, wherein said third party digital signature is applied to a control portion of said third party web page.

37. The method of claim 33, wherein said third party digital signature is applied to images from the group consisting of JPEG, JPG, GIF, MOV, AVI, MPEG, MPG or others, either static or animated.

38. The method of claim 33, where said third party digital signature excludes certain portions of said third party web content from said third party digital signature to allow an unapproved content to be displayed with an approved content.

39. The method of claim 33, further comprising said client accepting one or more said third party signed public keys in order to authenticate said web contents or portions thereof, received from more than one third party or OEM server or servers, either simultaneously, sequentially, or interlaced with said web content provided by the said third party servers or an OEM server.

40. The method of claim 33, further comprising allowing only the OEM to sign said third party public key.

41. The method of claim 33, wherein said third parties can sign other third party public keys as long as the first said signed third party public key presented to said client has been signed by the OEM and the others are presented to said client in the order of signage.

42-62. (Cancelled)
